(19) United States
(12) Patent Application Publication
(10) Pub. No.: US 2019/0170413 A1
(43) Pub. Date: Jun. 6, 2019

(54) ELECTRICAL MONITORING OF REFRIGERANT CIRCUIT

(71) Applicant: Johnson Controls Technology Company, Auburn Hills, MI (US)

(72) Inventors: Jay C. Walser, Norman, OK (US); James C. Perkins, Oklahoma City, OK (US)

(21) Appl. No.: 15/868,823

(22) Filed: Jan. 11, 2018

Related U.S. Application Data
(60) Provisional application No. 62/593,565, filed on Dec. 1, 2017.

(51) Int. Cl. F25B 49/00; G08B 21/18

(52) U.S. Cl. CPC F25B 49/005; F25B 2700/00; F25B 2500/222; G08B 21/182

(57) ABSTRACT

A leak detection system for heating, ventilating, and air conditioning (HVAC) equipment includes a refrigerant circuit, where the refrigerant circuit includes tubing configured to couple components in the refrigerant circuit and where the tubing is configured to enclose a refrigerant flowing throughout the refrigerant circuit. The leak detection system further includes a processor coupled to the tubing of the refrigerant circuit, where the processor is configured to detect a variation in physical geometry of the tubing by comparing the measured electrical property to a baseline measurement.

### CROSS REFERENCE TO RELATED APPLICATIONS

This application claims priority to and the benefit of U.S. Provisional Patent Application No. 62/593,565, entitled “Electrical Monitoring of Refrigerant Circuit,” filed Dec. 1, 2017, which is herein incorporated by reference in its entirety for all purposes.

### BACKGROUND

The present disclosure relates generally to environmental control systems, and more particularly, to a refrigerant circuit for an HVAC system.

Environmental control systems are utilized in residential, commercial, and industrial environments to control environmental properties, such as temperature and humidity, for occupants of the respective environments. The environmental control system may control the environmental properties through control of an airflow delivered to the environment. For example, a heating, ventilating, and air conditioning (HVAC) system routes refrigerant through a circuit to exchange heat with the airflow and ultimately increases or decreases a temperature of the airflow. The circuit may include a compressor, a condenser, a refrigerant, and tubing that connects the components together. In some cases, changes in physical geometry to the tubing may affect the functioning of the refrigerant circuit.

### SUMMARY

In one embodiment, a leak detection system for heating, ventilating, and air conditioning (HVAC) equipment includes a refrigerant circuit, where the refrigerant circuit includes tubing configured to couple components in the refrigerant circuit and where the tubing is configured to enclose a refrigerant flowing throughout the refrigerant circuit. The leak detection system further includes a processor coupled to the tubing of the refrigerant circuit, where the processor is configured to detect a variation in physical geometry of the tubing by comparing the measured electrical property to a baseline measurement.

In one embodiment, a system of leak detection for heating, ventilating, and air conditioning (HVAC) equipment includes a broadcaster configured to transmit current across tubing of the HVAC equipment, a receiver configured to receive electric signals indicative of a measured electrical property of the tubing, and a processor configured to analyze the measured electrical property of the tubing by comparing the measured electrical property to a baseline measurement of the electrical property.

In one embodiment, a method for detecting a variation in geometry for tubing in a heating, ventilation, and air conditioning (HVAC) system includes transmitting current across tubing, detecting a measured electrical property of the tubing, and comparing the measured electrical property with a threshold value of the electrical property to identify a variation of physical geometry of the tubing. The tubing is configured to transmit a refrigerant therethrough.

### DRAWINGS

FIG. 1 is a schematic of an environmental control for building environmental management that may employ one or more HVAC units, in accordance with an aspect of the present disclosure;

FIG. 2 is a perspective view of an embodiment of the environmental control system of FIG. 1, in accordance with an aspect of the present disclosure;

FIG. 3 is a schematic of a residential heating and cooling system, in accordance with an aspect of the present disclosure;

FIG. 4 is a schematic of an embodiment of a vapor compression system that can be used in any of the systems of FIGS. 1-3, in accordance with an aspect the present disclosure;

FIG. 5 is a schematic of an embodiment of a sensor system coupled to a tubing segment located in a refrigerant circuit in an HVAC unit, in accordance with an aspect of the present disclosure;

FIG. 6 is a schematic of the embodiment of a sensor system, in accordance with an aspect of the present disclosure;

FIG. 7 is a schematic of the embodiment of a sensor system coupled to a tubing segment containing a deformation or irregularity, in accordance with an aspect of the present disclosure;

FIG. 8 is an embodiment of a graph of electrical properties measured by a sensor system, in accordance with an aspect of the present disclosure;

FIG. 9 is a perspective view of an embodiment of an electrically isolated component in a refrigerant circuit in an HVAC unit, in accordance with an aspect of the present disclosure;

FIG. 10 is a block diagram of an embodiment of a process to calibrate a sensor system to measure electrical properties of a tubing segment, in accordance with an aspect of the present disclosure; and

FIG. 11 is a block diagram of an embodiment of a process to measure electrical properties of a tubing segment, in accordance with an aspect of the present disclosure.

### DETAILED DESCRIPTION

The present disclosure is directed to a sensor system for heating, ventilating, and air conditioning (HVAC) systems that direct a refrigerant through a refrigerant circuit. The refrigerant may flow through tubing within the circuit to facilitate heat transfer between an airflow and the refrigerant. The sensor systems disclosed herein are configured to detect deformation or other physical or geometric irregularity of the tubing or other components of the HVAC system. As described in greater detail below, the sensor system is configured to measure electrical properties of a component, such as a heat exchanger coil, in the HVAC system by transmitting a low current at a high frequency across the coil. Electrical properties of the coil may change based on the coil's configuration, such as a variation in the coil's physical geometry. Accordingly, the sensor system may detect the change in electrical properties to warn of potential geometric or physical irregularities in the coil.

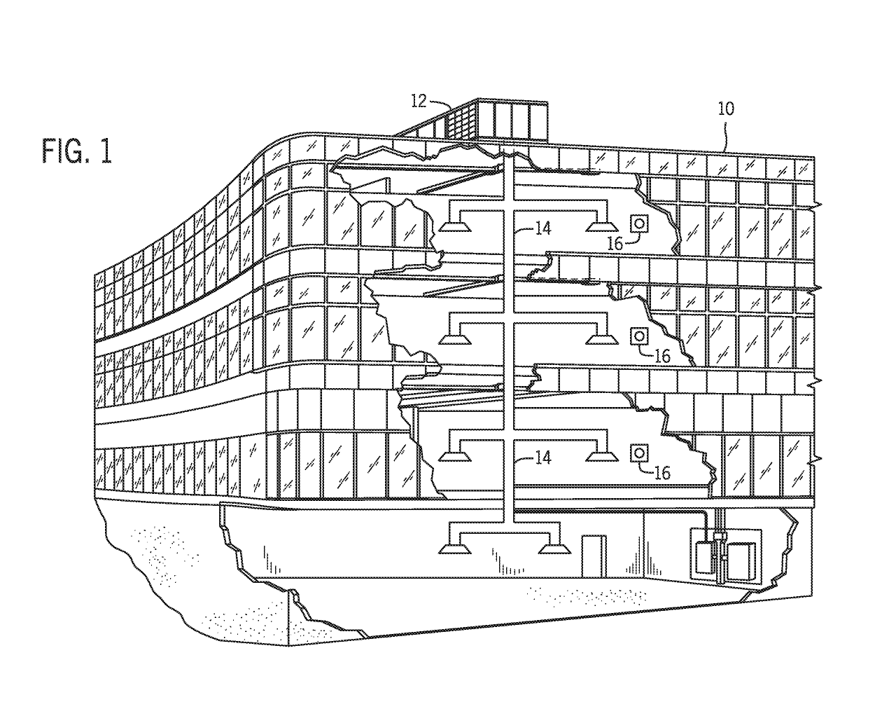

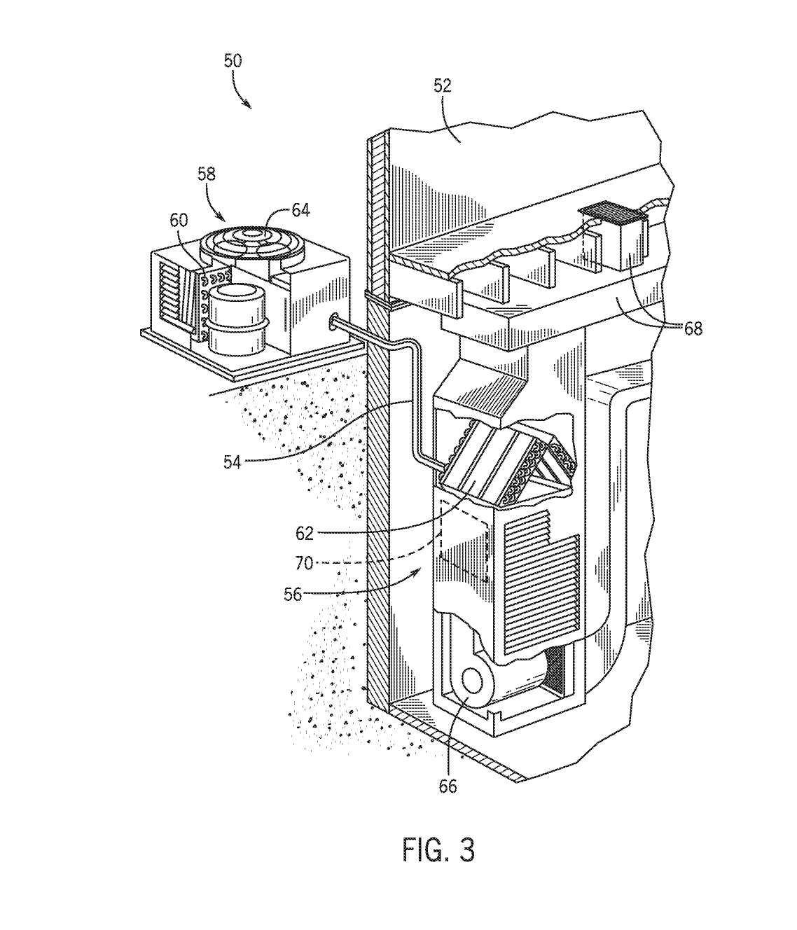

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

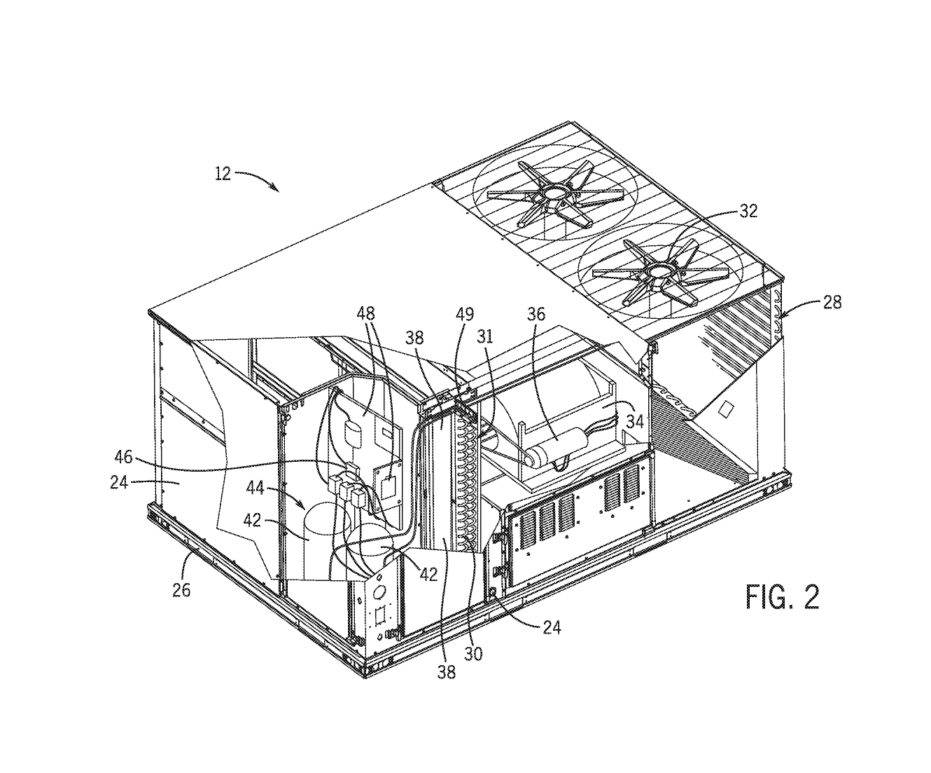

FIG. 2 is a perspective view of an embodiment of the HVAC unit 12. In the illustrated embodiment, the HVAC unit 12 is a single packaged unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant through the heat exchangers 28 and 30. For example, the refrigerant may be R-410A. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger separate from heat exchanger 62, such that air directed by the blower 66 passes over the tubes or pipes and extracts heat from the combustion products. The heated air may then be routed from the furnace system 70 to the ductwork 68 for heating the residence 52.

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed, embodiments of the present disclosure are directed to the HVAC unit 12 having a system for measuring electrical properties of tubing in a refrigerant circuit of the HVAC unit 12. For example, a tubing segment in the refrigerant circuit, such as a heat exchanger coil, may be coupled to a system that measures capacitance and resistance of the tubing segment. The system may contain a control board electrically coupled to the tubing segment that sends a high frequency, low current over the surface of the tubing segment. To this end, the tubing segment may be made out of metal or another electrically conductive material to enable the current to travel a length or portion of the tubing segment. In some embodiments, when the current encounters a variation in physical geometry of the tubing, the system may detect a variation in the electronic signals, such an electrical signal deflection, that are sent back to the system. In other embodiments, the system may use the current to measure the values of resistance and/or capacitance of the tubing segment, and these values may vary or change when the current encounters a variation in physical geometry of the tubing segment. The system may output a signal for further actions if the system detects signal deflection beyond a threshold or if the detected capacitance and/or resistance values of the tubing segment are outside of an acceptable or predetermined range of values. The system may detect deformation and/or irregularity in the tubing, such as bending, and, in some embodiments, may detect the location of the deformation and/or irregularity immediately or shortly after the deformation and/or irregularity occurs. Such deformation or irregularity in the tubing segment may decrease the performance of the HVAC unit 12 and/or may lead to further deformation and/or irregularity in other components of the HVAC unit 12. As a result, the disclosed system for measuring electrical properties may save costs of inspection and maintenance of the refrigerant circuit.

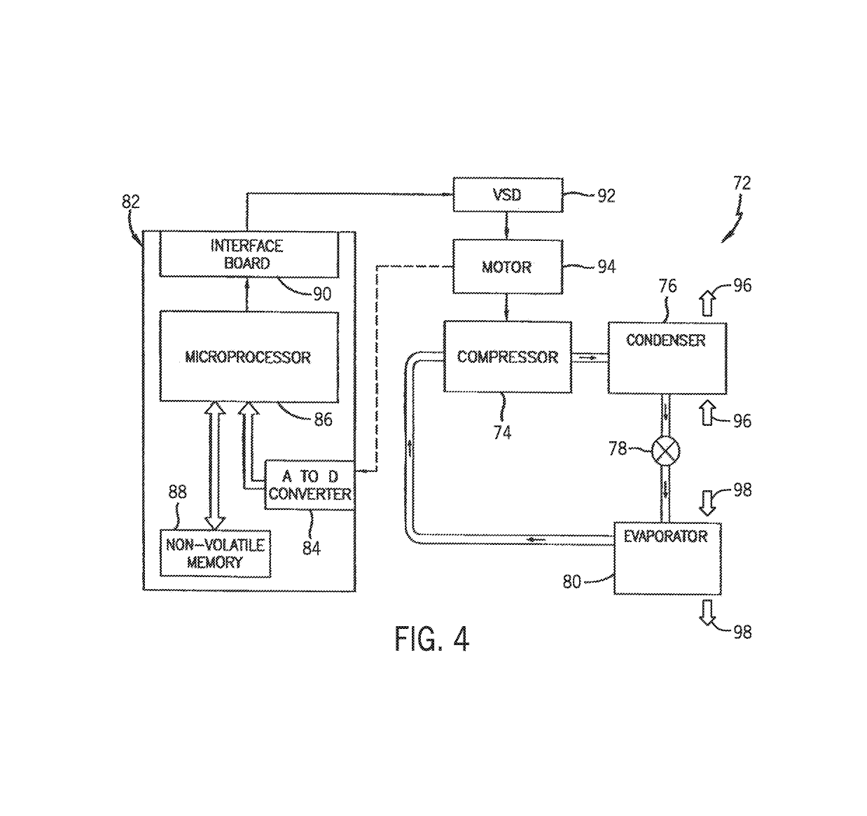

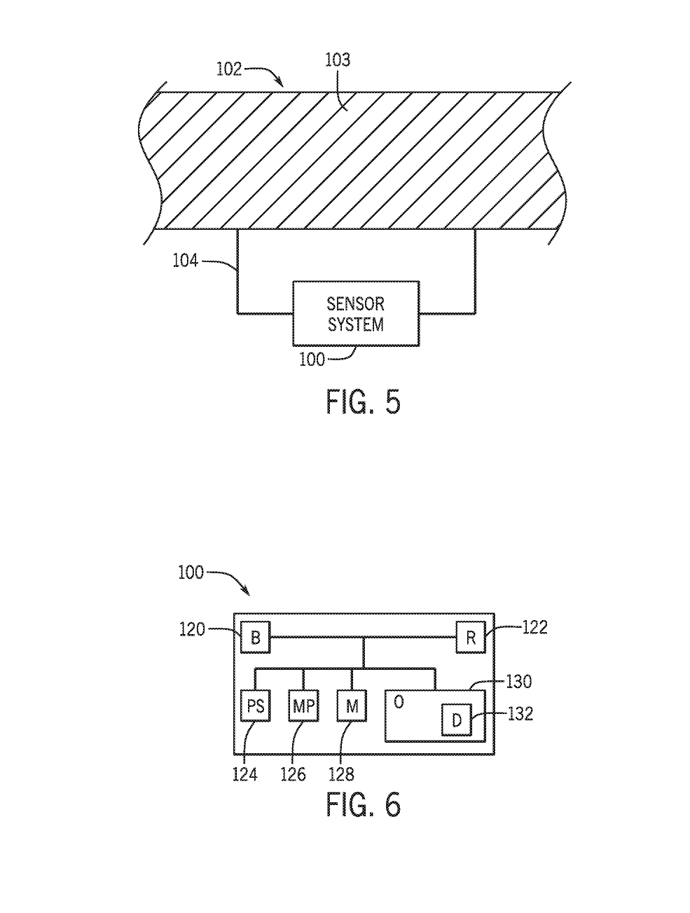

For example, FIG. 5 is a schematic view of an embodiment of a sensor system 100 that may be used with the HVAC unit 12. In the figure, the sensor system 100 is in electrical communication with tubing segment 102 and measures electrical properties of the tubing segment 102. The tubing segment 102 is a section in the refrigerant circuit of the HVAC unit 12, and refrigerant may flow through the tubing segment 102. For example, the refrigerant in the tubing segment 102 may be in thermal communication with air flowing through the HVAC unit 12. For purposes of discussion, the tubing segment 102 will be referred as a segment of coil in a heat exchanger, such as an evaporator, but it should be appreciated that the tubing segment 102 may also be located in another component of the refrigerant circuit in the HVAC unit 12, such as a compressor or condenser. Over time, the tubing segment 102 may experience deformation and/or irregularity due to usage and operation. For example, the coil may undergo thermal stress from fluctuation of temperature of the refrigerant during heat exchange with the air flow. This may cause the tubing segment 102 to expand and contract in diameter, which may eventually result in a variation, such as a permanent variation, in physical geometry of the tubing segment 102. The variation in physical geometry may result in a change of electrical properties of the tubing segment 102. The sensor system 100 may detect the change of electrical properties and may be able to output a signal indicating the detection.

In order to measure the electrical properties of the tubing segment 102, the sensor system 100 may transmit a low current across the tubing segment 102, such as across an outer surface 103 of the tubing segment 102. In some embodiments, the tubing segment 102 may be a coil, and the sensor system 100 may transmit the current across an entire length of the coil. If there is a variation in physical geometry, a variation in electronic signals may reflect back to the sensor system 100. In other embodiments, the tubing segment 102 is a section of the coil, and the sensor system 100 may measure electrical property values of that section of coil. The sensor system 100 may transmit the current across the tubing segment 102 and may receive the transmitted current after the current travels across a length of the tubing segment 102. From the received current, the sensor system 100 may be able to measure electrical properties of the tubing segment 102. To send and receive the current, the sensor system 100 may be electrically coupled to the tubing segment 102 via electrical connections 104. The electrical connections 104 may be wires or any other components that allow current to flow between the sensor system 100 and the tubing segment 102. Furthermore, the tubing segment 102 may be electrically isolated from ground so that the traveling of the current is not interfered. To facilitate conductivity, the tubing segment 102 may be made of material such as a metal, such as copper, a semimetal, another material that may conduct electricity, or any combination of materials thereof. There may also be multiple sensor systems 100 used with the HVAC unit 12, and each sensor system 100 may be placed at any section of the refrigerant circuit to measure the electrical properties of the respective sections of the refrigerant circuit. For example, in some embodiments, the tubing segment 102 may contain multiple sensor systems 100, where each sensor system 100 measures a different section of the tubing segment 102.

FIG. 6 is a schematic view of the sensor system 100, illustrating components of the sensor system 100. For example, the sensor system 100 may contain a broadcaster 120 and a receiver 122. The broadcaster 120 may transmit the low current at a high frequency to the tubing segment 102. The receiver 122 may receive the low current after the current has traveled across the tubing segment 102. The sensor system 100 may also contain a power source 124 that provides power to the sensor system 100 to function. Further, the sensor system 100 may contain a microprocessor 126 that can execute instructions to measure electrical properties of the tubing segment 102. In some embodiments, such as if the sensor system 100 measures an entire length of a heat exchanger coil, the microprocessor 126 may be electrically coupled to the tubing and may measure the electrical properties from reflected electronic signals. In other embodiments, such as if the sensor system 100 measures a segment or portion of the coil, the microprocessor 126 may use the current received by the receiver 122 to measure the resistance and/or capacitance values of the segment of the coil and compare to a baseline value. In either case, the microprocessor 126 may detect a variation in physical geometry of the tubing via the measurements. The microprocessor 126 may also adjust the current transmitted by the broadcaster 120 based on the measured electrical properties obtained by the receiver 122. For example, the microprocessor 126 may adjust the current's ampere value or the frequency at which the broadcaster 120 transmits the current. The microprocessor's executable instructions may be stored in a memory 128. The memory 128 may also store a set of threshold values associated with electrical properties of an unaltered segment of tubing.

After measuring the electrical properties, the microprocessor 126 may transmit a signal to an output unit 130. The output unit 130 may be coupled with a display 132 for displaying the measured electrical properties. For example, the display 132 may show a graph of the measured resistance and/or capacitance of the tubing segment 102 over time. When the measured electrical properties exceed threshold values, thereby indicating a possible variation of physical geometry of the tubing segment 102, the output unit 130 may create a warning or alarm associated with the change in geometry. For example, the output unit 130 may show an error on the display 132 or the output unit 130 may output an auditory alarm. To determine the threshold values for the electrical properties, the sensor system 100 may first undergo a calibration process. The calibration process obtains measurements of the electrical properties of the tubing segment 102 under normal operations, such as without modified or deformed components. The calibration process may then use the initial measurements to determine a baseline value for normal operation and/or threshold values indicating changes in physical geometry that should be identified by the sensor system 100.

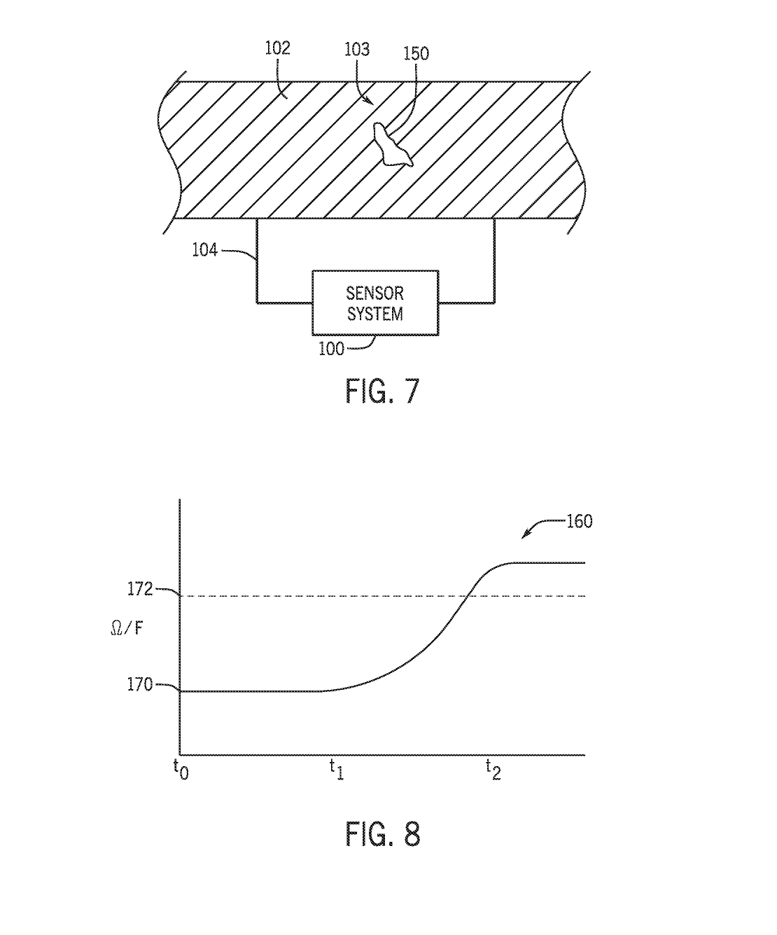

FIG. 7 is a schematic of an embodiment of the sensor system 100 and the tubing segment 102, illustrating a physical deformation 150 in the tubing segment 102. As discussed, the tubing segment 102 may undergo thermal stress due to fluctuation in temperature, which may eventually result in a variation of physical geometry of the tubing segment 102. The variation of physical geometry may lead to a change in an electrical property that is measured by the sensor system 100. In some embodiments, the variation of physical geometry may increase the deflection of the capacitance and/or resistance of the current. In other embodiments, the variation of physical geometry may change the measured capacitance and/or resistance of the tubing segment 102. For example, the formation of the physical deformation 150 may increase the measured resistance value of the tubing segment 102. As will be appreciated, the change in physical geometry, such as the physical deformation 150, may include an expansion of the diameter, a bend, a twist, any other physical variation, or any combination thereof of the tubing segment 102.

FIG. 8 is a graph 160 of a measurement 170 of an electrical property of the tubing segment 102 over time. The measurement 170 may be associated with a deflection of electrical properties or a measurement of electrical properties after a current has traveled a length of the tubing segment 102. As discussed above, the electrical property may be resistance or current. A threshold value 172 may depict a maximum acceptable or baseline value of the electrical property to indicate normal operations and normal physical geometry of the tubing segment 102, as determined by calibration. At t₀, the measurement 170 may be at a value, such as a baseline value, below the threshold value 172 to indicate normal operations and physical geometry. At t₁, a physical deformation or irregularity may be forming in the tubing segment 102 and the measurement 170 may begin to increase. Eventually, the measurement 170 may exceed the threshold value 172, as shown at t₂, which may indicate a physical geometry deformation that may inhibit the functioning of the HVAC unit 12. When the measurement 170 exceeds the threshold value 172, it may lead to a warning, such as a display or an alarm, indicating the variation of physical geometry and prompting attention to the tubing segment 102, such as maintenance or repair. In some embodiments, the amount that the measurement 170 exceeds the threshold value 172 may result in a different output. For example, the amount exceeded may be utilized to determine the type of variation of physical geometry in the tubing segment 102, such as a bend or an expansion of diameter, and the output may cause the sensor system 100 to display the suggested type of variation of physical geometry on the display 132. As such, a more suitable form of maintenance, repair, or other attention to the tubing segment 102 may be prompted.

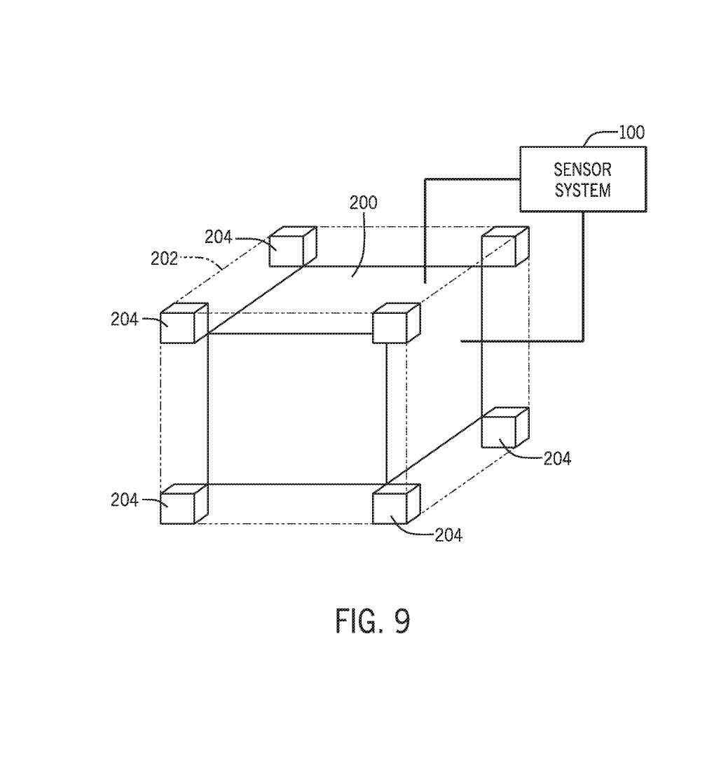

FIG. 9 is a schematic perspective view of a refrigerant circuit component 200 in the HVAC unit 12. The refrigerant circuit component 200 may be enclosed by a frame 202 that surrounds an entirety of the component 200. The refrigerant circuit component 200 may be coupled to the sensor system 100 to measure electrical properties of the refrigerant circuit component 200. In some embodiments, the refrigerant circuit component 200 may be a heat exchanger, and the sensor system 100 may be coupled to a coil of the heat exchanger. In other embodiments, the component 200 may be any other portion of the HVAC unit 12, such as a compressor, evaporator, condenser, expansion valve, and so forth.

In order for the sensor system 100 to transmit and receive current properly and to measure the electrical properties of the refrigerant circuit component 200 accurately, the refrigerant circuit component 200 may be isolated from ground. That is, the refrigerant circuit component 200 may use isolating elements 204 that separate the component 200 from the frame 202. The isolating elements 204 may be bushings, rubber bumpers, insulations, other components that may electrically isolate the refrigerant circuit component 200 from the frame 202, or any combination thereof. In this manner, there may not be elements interfering with the electrical circuit that is generated by the sensor system 100 and/or the section of the refrigerant circuit component 200 that is charged with the current supplied by the sensor system 100.

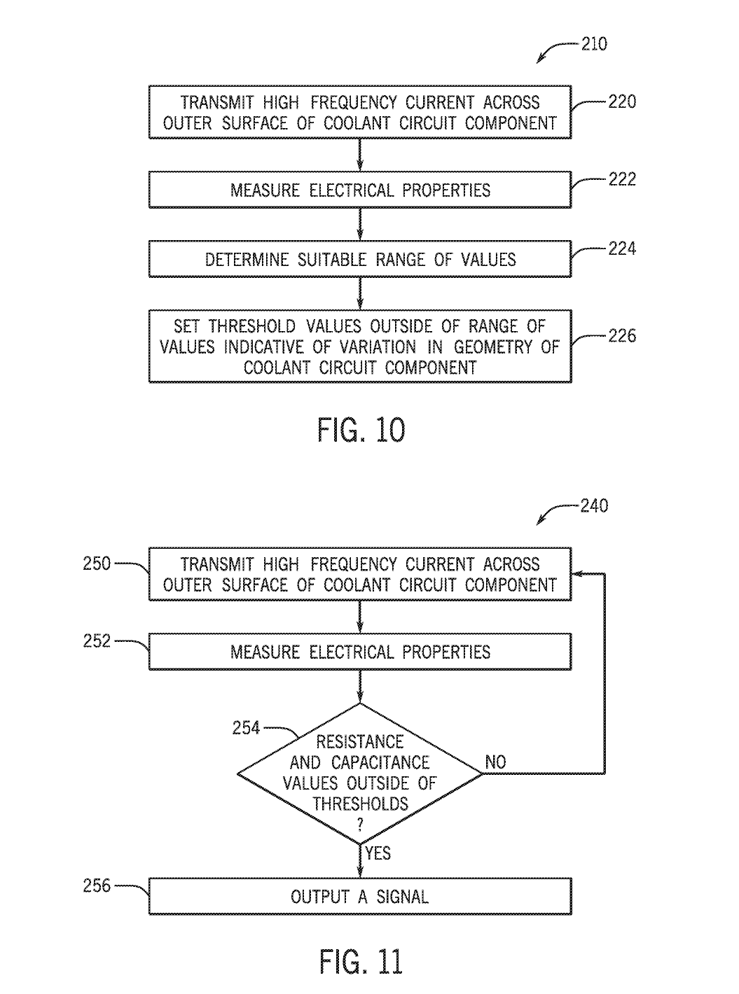

FIG. 10 illustrates an embodiment of a method 210 used by the sensor system 100 to calibrate the measurements of electrical properties of the tubing segment 102 prior to full operation of the sensor system 100. At block 220, the sensor system 100 may transmit current at a high frequency across the tubing segment 102. The tubing segment 102 may be free of deformities or other physical changes that may deviate its electrical properties from values during normal operations. At block 222, the sensor system 100 may measure the resistance and/or capacitance associated with the tubing segment 102. In some embodiments, the sensor system 100 may measure based off the deflected signal. In other embodiments, the sensor system 100 may measure based off the current after the current has traveled across a length of the tubing segment 102. At block 224, the sensor system 100 may determine a suitable range of resistance and capacitance values based on the measurements taken when the tubing segment 102 remains physically unaltered.

At block 226, the sensor system 100 may set threshold values associated with resistance and/or capacitance values that may indicate a variation of physical geometry of tubing segment 102. The threshold value may also be selected to prevent or reduce false positives. For example, debris, such as leaves or dirt, contacting the tubing segment 102 may alter the electrical properties of the tubing segment 102 measured by the sensor system 100. To avoid such a detection being interpreted as a variation in physical geometry of the tubing segment 102, which could be considered a false positive, the threshold value may be of sufficient magnitude to indicate changes in physical geometry of the tubing segment 102. For example, the threshold value may be empirically determined and/or associated with a type of physical geometry deformation or irregularity sought to be detected. In some embodiments, the sensor system 100 may perform additional processing to prevent or reduce false positives. In additional embodiments, the sensor system 100 may adjust properties of the transmitted current based at least on the measured electrical properties, such as to modify the current to be able to receive suitable measurements of electrical properties reflecting the configuration of the tubing segment 102.

FIG. 11 illustrates an embodiment of a method 240 used by the sensor system 100 to measure the electrical properties of the tubing segment 102 during normal operation. At block 250, the sensor system 100 may transmit a high frequency current across the tubing segment 102. At block 252, the sensor system 100 may measure the resistance and/or capacitance of the tubing segment 102. As discussed, the sensor system 100 may detect physical geometry irregularities of the tubing segment 102 based off a deflected signal or the current after it has traveled across a length of tubing segment 102. In any case, at block 254, the sensor system 100 may compare the values of the measured resistance and/or capacitance with the threshold values determined by the method 210 described in FIG. 10. If the measured values do not exceed the threshold values, the sensor system 100 repeats blocks 250 to 254 to continue to measure the electrical properties of the tubing segment 102. However, if the measured resistance and capacitance values exceed the threshold values, the sensor system 100 may output a signal as shown at block 256. The signal may be used to alert that a variation of physical geometry of the tubing segment 102 has occurred. For example, the signal may display a notification or may sound an alarm. Furthermore, in some embodiments, method 210 and 240 may be performed by a processor, such as the microprocessor 126, which may be attached to or may be a component of the sensor system 100.

As set forth above, embodiments of the sensor system of the present disclosure may provide one or more technical effects useful in the detection of variation of physical geometry of refrigerant or refrigerant circuit components HVAC systems. For example, the sensor system may measure electric properties of the component and detect when the electric properties deviate from values during normal operation. The sensor system may transmit a low current at a high frequency across a tubing segment, such as a heat exchanger coil. In some embodiments, the sensor system monitors an entire length of tubing and detects electric signals reflected back due to a variation in physical geometry of the monitored tubing segment. In other embodiments, the sensor system measures a segment of tubing and detects electric signals after the current has traveled a length of the tubing segment. In any case, the sensor system uses the electric signals to compare measured electric properties with that during normal operations. If the measured electric properties exceed a threshold, the sensor system may perform further action to indicate the detection. Thus, undesired or unintended variations in physical geometry of refrigerant circuit components may be detected. The technical effects and technical problems in the specification are examples and are not limiting. It should be noted that the embodiments described in the specification may have other technical effects and can solve other technical problems.

While only certain features and embodiments of the present disclosure have been illustrated and described, many modifications and changes may occur to those skilled in the art, such as variations in sizes, dimensions, structures, shapes and proportions of the various elements, values of parameters, mounting arrangements, use of materials, colors, orientations, etc., without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed subject matter. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A leak detection system for heating, ventilating, and air conditioning (HVAC) equipment, comprising:
a refrigerant circuit, wherein the refrigerant circuit comprises tubing configured to couple components in the refrigerant circuit, wherein the tubing is configured to enclose a refrigerant flowing throughout the refrigerant circuit; and
a processor coupled to the tubing of the refrigerant circuit, wherein the processor is configured to detect a variation in physical geometry of the tubing by comparing the measured electrical property to a baseline measurement.

2. The system of claim 1, wherein the tubing is electrically isolated from ground.

3. The system of claim 2, wherein the refrigerant circuit is electrically isolated from ground.

4. The system of claim 1, wherein the processor is electrically coupled to the tubing.

5. The system of claim 4, wherein the processor is part of a sensor system, the sensor system comprising a broadcaster configured to transmit the current across the tubing.

6. The system of claim 5, wherein the sensor system is configured to send an alert signal when the measured electrical property is outside of a range of predetermined values.

7. The system of claim 1, wherein the refrigerant circuit comprises a heat exchanger comprising a coil configured to flow the refrigerant and establish a heat exchange relationship between the refrigerant and an air flow, wherein the tubing is coupled to the heat exchanger.

8. The system of claim 7, wherein the processor is disposed on the coil of the heat exchanger.

9. The system of claim 1, wherein the measured electrical property comprises capacitance, resistance, or any combination thereof.

10. The system of claim 1, wherein the tubing comprises copper, aluminum, stainless steel, or any combination thereof.

11. A system of leak detection for heating, ventilating, and air conditioning (HVAC) equipment, comprising:
a broadcaster configured to transmit current across tubing of the HVAC equipment;
a receiver configured to receive electric signals indicative of a measured electrical property of the tubing; and
a processor configured to analyze the measured electrical property of the tubing and detect a variation in physical geometry of the tubing by comparing the measured electrical property to a baseline value of the measured electrical property.

12. The system of claim 11, wherein the measured electrical property comprises capacitance, resistance, or a combination thereof.

13. The system of claim 11, wherein the baseline value is based at least on a calibrated value of the measured electrical property calculated before normal operation of the HVAC equipment.

14. The system of claim 11, wherein the processor is configured to adjust the current transmitted by the broadcaster based on the measured electrical property analyzed by the processor.

15. The system of claim 11, wherein the processor is configured to output a signal indicative of the variation in physical geometry when the measured electrical property exceeds the baseline value.

16. The system of claim 15, wherein the signal comprises activating an alarm.

17. The system of claim 15, wherein the processor is configured to determine a type of the variation in physical geometry based on an amount that the measured electrical property exceeds the baseline value.

18. The system of claim 11, comprising a display configured to display a measured value of the measured electrical property.

19. The system of claim 11, wherein the broadcaster and the receiver are each electrically coupled to the tubing.

20. A method for detecting variation in geometry for tubing in a heating, ventilation, and air conditioning (HVAC) system, comprising:
transmitting current across tubing, wherein the tubing is configured to transmit a refrigerant therethrough;
detecting a measured electrical property of the tubing; and
comparing the measured electrical property with a threshold value of the measured electrical property to identify a variation of physical geometry of the tubing.

21. The method of claim 20, comprising receiving the current from the tubing with a receiver after the current has traveled across the tubing.

22. The method of claim 20, comprising outputting a signal indicative of the variation of the physical geometry of the tubing when the measured electrical property exceeds the threshold value of the electrical property.

23. The method of claim 22, wherein the signal comprises a visual display signal, an auditory alarm signal, or both.

24. The method of claim 20, wherein detecting the measured electrical property comprises detecting a capacitance, resistance, or both, of the tubing.

25. The method of claim 20, wherein transmitting current across tubing comprises transmitting current through an outer surface of the tubing.
